(19) United States
(12) Patent Application Publication
(10) Pub. No.: US 2019/0208078 A1
(43) Pub. Date: Jul. 4, 2019

(54) PATTERN AND SPECTRUM SECURITY ONE-TIME PRINTING OF PACKAGING VERIFICATION METHOD

(71) Applicant: Printing Technology Research Institute, New Taipei (TW)

(72) Inventors: Shih-Chang CHANG, New Taipei (TW); Chia-Pin CHUEH, New Taipei (TW); Kang-Yu LIU, New Taipei (TW)

(21) Appl. No.: 15/858,859

(22) Filed: Dec. 29, 2017

(51) Int. Cl. H04N 1/32; G06K 9/46; G06K 9/62

(52) U.S. Cl. CPC H04N 1/32309; H04N 1/32251; H04N 1/32325; H04N 1/32267; H04N 2201/3259; G06K 9/6201; H04N 2201/0084; H04N 2201/3235; H04N 2201/3236; G06K 9/4652

(57) ABSTRACT

A pattern and spectrum security one-time printing of packaging verification method for verifying the authenticity of an external packing container of a commodity, which external packing container is printed with a security pattern on the surface using a specific spectrum of tangible fluorescent ink. The user checks the location of the security pattern by visualizing the tangible fluorescent ink on the external packing container, and then uses image capturing device to shoot the security pattern through a filter to capture the pattern image of the tangible fluorescent ink, a processor of the identification system loads in the captured pattern image, a software program in the processor matches the spectral band and shape of the captured pattern image with storage data in the database to verify the authenticity of the security pattern. The user can identify the authenticity of the commodity, enhancing commodity security and reducing the risk of being forged.

### FIELD OF THE INVENTION

The present invention relates to commodity verification technology and more particularly, to a pattern and spectrum security one-time printing of packaging verification method, which uses an image capturing device with a filter to capture the pattern image of a tangible fluorescent ink of a security pattern on the external packing container of the commodity, enabling a processor to match the spectral band and shape of the captured pattern image with storage data in a database verifying the authenticity of the commodity.

### DESCRIPTION OF THE RELATED ART

Today's technology and people's living standards keep upgrading, more and more products have been appeared on the market now, so that consumers have more choices in the purchase of products.

However, as high-price and high-quality merchandise become hot sale items, they are easily counterfeited by unscrupulous merchants. Unscrupulous traders may attempt to seek illegal interests by using fake packaging, printing and product shape. This situation will not only lead to serious losses of manufacturers, consumers buy counterfeit goods will also affect their own interests.

In order to prevent the occurrence of counterfeiting, the original manufacturers or agents will implement anti-counterfeit labels or other anti-counterfeit designs on the outer surfaces of the outer boxes of their goods to instruct consumers to identify the authenticity of their goods. However, cunning unscrupulous traders not only counterfeit their products, but also counterfeit the related anti-counterfeit labels, resulting in consumer confusion.

Although today's anti-counterfeiting technology includes bar codes, laser tags and special markings for the general consumer to identify authenticity, there is still a major hidden danger in the modern social economy that the conventional anti-counterfeiting measures still cannot effectively stop the evil deeds of unscrupulous practitioners who wish to imitate.

FIGS. 5 and 6 illustrates a QR code (quick response code) printed on an anti-counterfeiting label for adhering to the surface of the outer box of a product. A user can use a smart phone to recognize and decode the QR so as to quickly get the anti-counterfeit verification code, product serial number and product logo and other related information for the verification of the authenticity of the goods. However, in the production of the outer box or package, a decorative designs, patterns or letters are usually printed on the outer surface of the outer box or package to make the product more aesthetically pleasing or more descriptive, and the security label sticker with a two-dimensional bar code is then adhered to outer box or package. This anti-counterfeit measure not only needs to carry out the production of security label stickers, and a secondary security label sticker adhering procedure is necessary after printing of the outer box or package. This will increase the processing procedure, wasting hours and costs. Because an anti-counterfeit label cannot be incorporated into the decorative design or pattern on the surface of an outer box or package, the aesthetic appearance of the outer box or package will be affected. Further, the labeling operation is less environmentally friendly and difficult to implement energy-saving and carbon reduction and environmental protection. Further, conventional counterfeit anti-counterfeit labels of two-dimensional bar code can easily be counterfeited, thus, the internal information of the two-dimensional bar code can be forged or cracked, failing to achieve full security features. Further, because an anti-counterfeiting label is adhered to the outer surface of the outer box, an unscrupulous person can remove the anti-counterfeiting label from the outer box and then adhere the anti-counterfeiting label to the outer box of a counterfeit product for trafficking profit. A new counterfeit design is necessary to solve the above-mentioned problems.

### SUMMARY OF THE INVENTION

The present invention has been accomplished under the circumstances in view. It is therefore the main object of the present invention to provide a pattern and spectrum security one-time printing of packaging verification method for verifying the authenticity of an external packing container of a commodity, which external packing container is printed with a security pattern on the surface thereof using a specific spectrum of tangible fluorescent ink. The user can visually check the location of the security pattern by visualizing the tangible fluorescent ink on the external packing container, and then use an image capturing device to shoot the security pattern through a filter so as to capture the pattern image of the tangible fluorescent ink, and then a processor of the identification system is enabled to load in the captured pattern image, and then a software program in the processor is enabled to match the spectral band and shape of the captured pattern image with storage data in the database so as to verify the authenticity of the security pattern. Thus, the user can clearly identify the authenticity of the commodity. The specific spectrum band and shape of the security pattern provide multiple anti-counterfeiting mechanisms that cannot be easily counterfeited, enhancing commodity security and reducing the risk of being forged.

According to another aspect of the present invention, the security pattern is printed using a specific spectrum of tangible fluorescent ink to show a distinct bright color, which is different from the color gamut printed by ordinary ink, and thus it can be used as the first anti-counterfeiting mechanism of the present invention. Because the security pattern can be printed in one time and combined with the established pattern on the surface of the external packing container, it can not only eliminate a label production procedure to simplify the processing procedure and to save labor and cost, but also do not affect the sense of beauty of the overall appearance of the external packing container and achieve implementation of energy saving carbon reduction and environmental protection.

According to another aspect of the present invention, when a user uses an image capturing device with a filter to shoot the security pattern, the image capturing device will simply capture the pattern image of the specific spectrum of tangible fluorescent ink. In case of a counterfeit security pattern using a fluorescent ink of a different spectral band, the captured pattern image will show broken lines or incomplete shape, and the matching result will be rejected. The software program matches the spectral band of the pattern image with the preset tangible fluorescent ink data in the database first, and then matches the shape of the pattern image with the preset tangible fluorescent ink data in the database when the spectral band matched, achieving a second anti-counterfeit mechanism.

According to still another aspect of the present invention, when the processor uses the software program to identify the spectral band and shape within the image color block of the pattern image of the security pattern, the software program matches the spectral band and shape of the pattern image with the preset tangible fluorescent ink data in the database for similar percentage comparison, and the matching is proved acceptable only when similar percentage reaches at least 98%. This procedure provides a third anti-counterfeit mechanism.

Other advantages and features of the present invention will be fully understood by reference to the following specification in conjunction with the accompanying drawings.

### BRIEF DESCRIPTION OF THE DRAWINGS

FIG. 1 is a flow chart of a pattern and spectrum security one-time printing of packaging verification method in accordance with the present invention.

FIG. 2 illustrates the outer appearance of a security pattern on the surface of an external packaging container of a commodity.

FIG. 3 is a schematic drawing of a security pattern captured by an image capturing device of an identification system through a filter.

FIG. 4 is a schematic drawing illustrating the implementation of the pattern and spectrum security one-time printing of packaging verification method.

FIG. 5 is a schematic plain view of a conventional QR code printing matter.

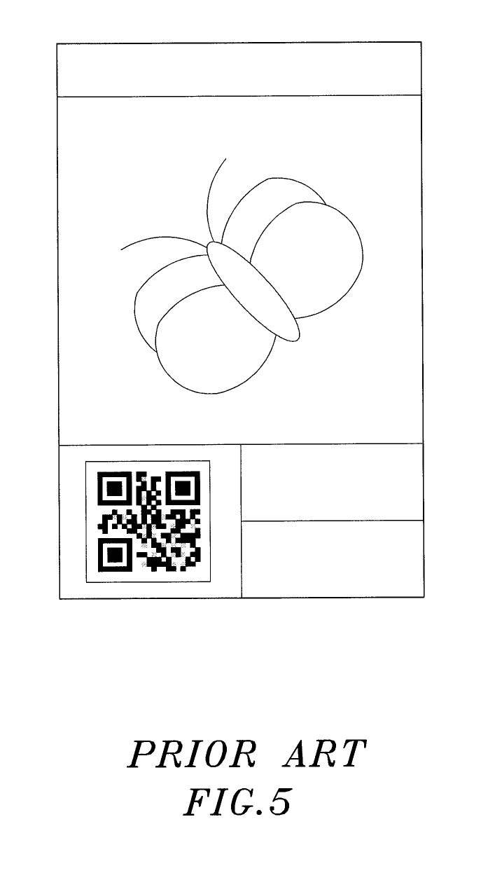

FIG. 6 illustrates the outer appearance of a QR code.

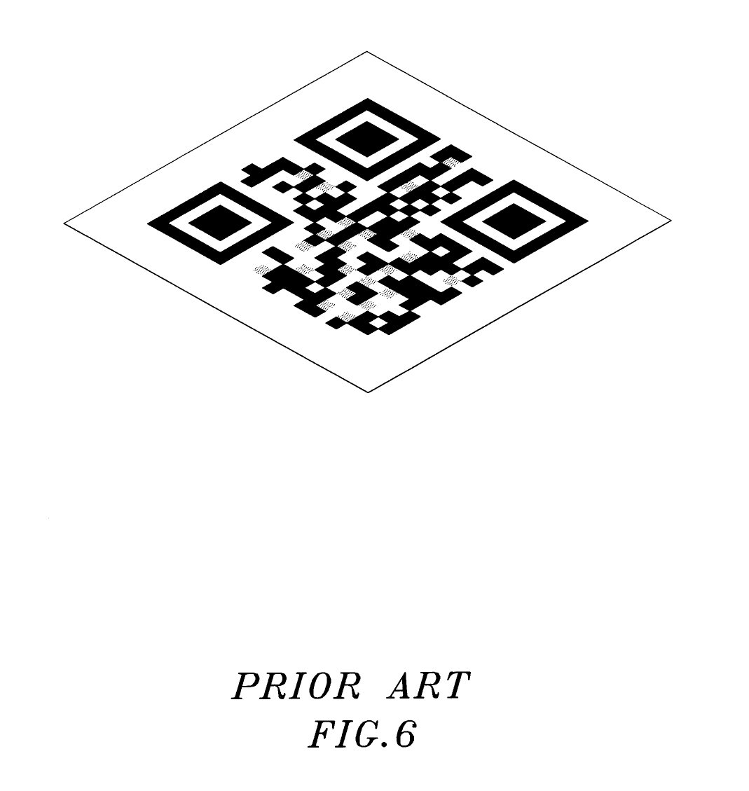

### DETAILED DESCRIPTION OF THE PREFERRED EMBODIMENT

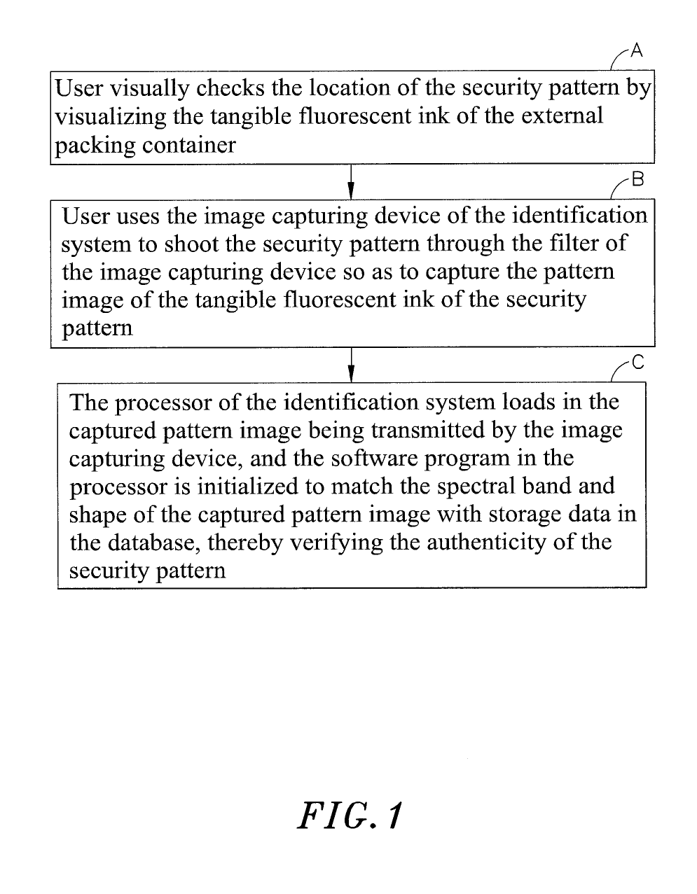

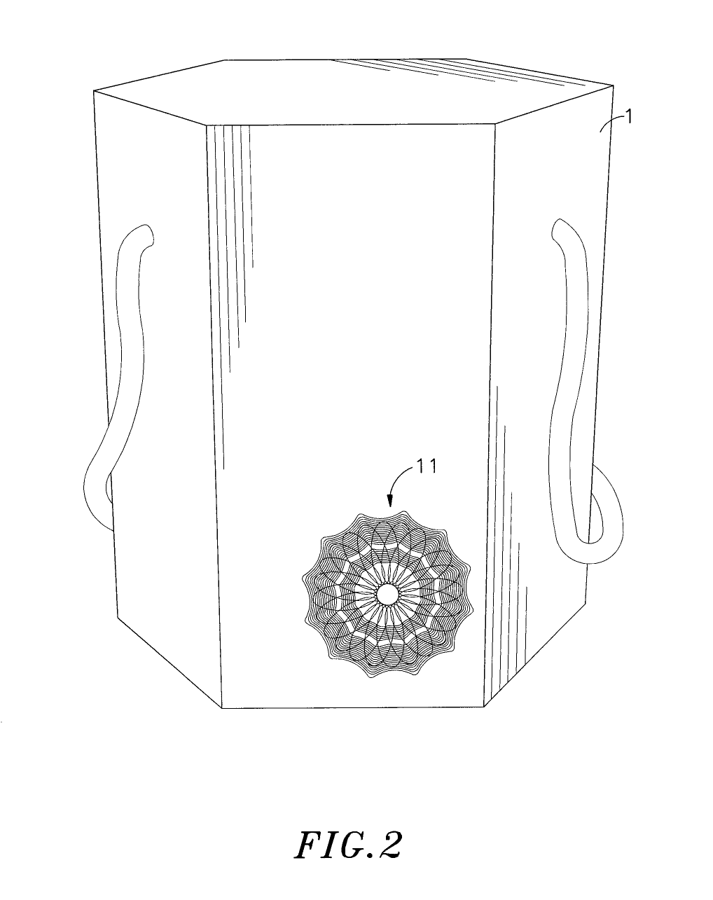

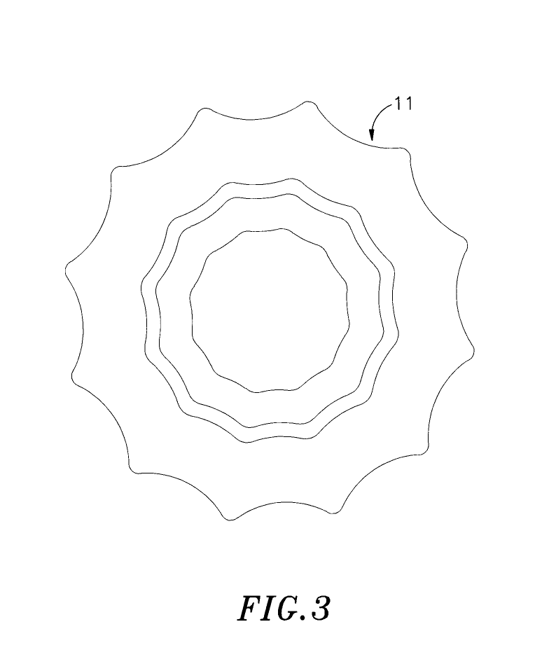

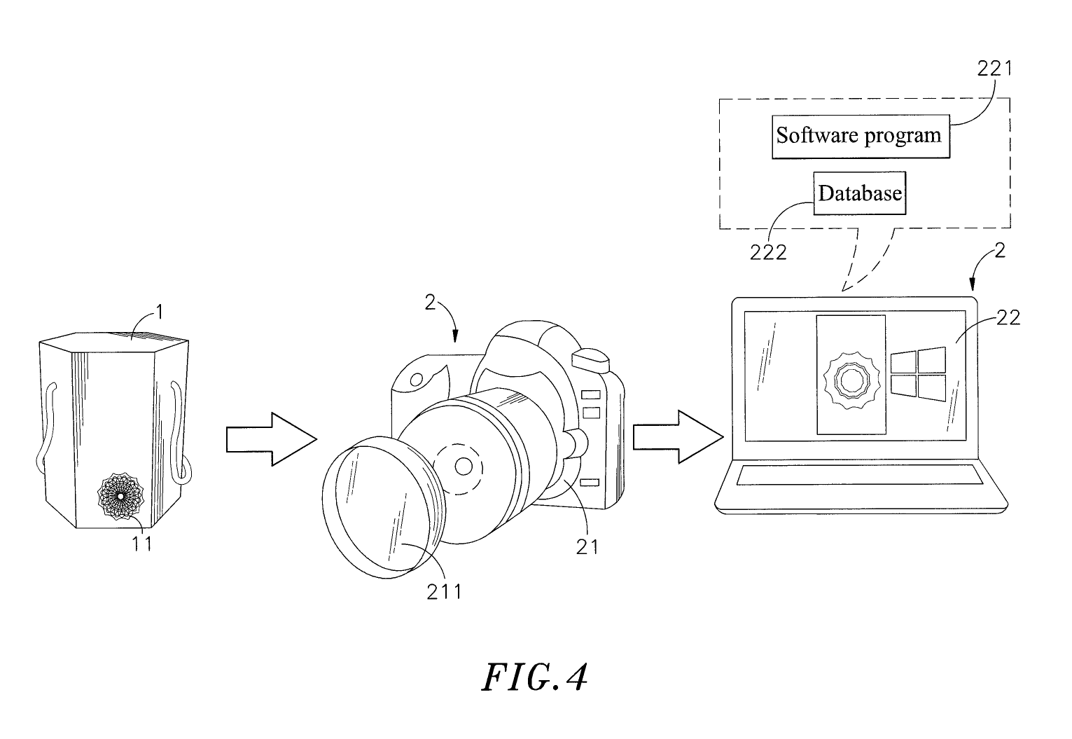

Referring to FIGS. 1-4, a pattern and spectrum security one-time printing of packaging verification method in accordance with the present invention is adapted for verifying the authenticity of an external packaging container 1 (such as wrapping paper, paper box or plastic box) of a commodity. The external packing container 1 is printed with a security pattern 11 on the surface using a specific spectrum of tangible fluorescent ink. The tangible fluorescent ink is prepared by adding a fluorescent material to a colored ink. The spectral band of the tangible fluorescent ink of the external packing container 1 can be in the range of 400˜700 nm of visible light so that the security pattern 11 on the surface of the external packing container 1 is visible to naked eyes under natural light. The security pattern 11 does not have any barcode format, such as one-dimensional barcode of common coding rules, QR code of two-dimensional barcode, PDF 417 barcode or matrix barcode so that the security pattern 11 can be directly printed on the surface of the external packing container 1 in one time and incorporated into a predetermined pattern. The security pattern 11 has a geometric shape of intersections of color and lines, and the color of the security pattern 11 contains yellow, orange, red, green, blue, etc. or any combination thereof.

In application, a user can use an identification system 2 to verify the authenticity of the external packing container 1 through the steps as follows:

(A) The user visually checks the location of the security pattern 11 by visualizing the tangible fluorescent ink on the surface of the external packing container 1.

(B) The user uses an image capturing device 21 of the identification system 2 to shoot the security pattern 11 through a filter 211 of the image capturing device 21 so as to capture the pattern image of the tangible fluorescent ink of the security pattern 11.

(C) A processor 22 of the identification system 2 loads in the captured pattern image being transmitted by the image capturing device 21, and a software program 221 in the processor 22 is initialized to match the spectral band and shape of the captured pattern image with storage data in the database 222, thereby verifying the authenticity of the security pattern 11.

It is clear from the above implementation steps, when the user visually observed through the naked eye that the external packing container 1 appears the tangible fluorescent ink on the surface, the user can determine the location of the security pattern 11 according to the tangible fluorescent ink. Because the tangible fluorescent ink is formulated with a specific spectrum, the security pattern 11 can show a distinct bright color, which is different from the color gamut printed by ordinary ink, and thus it can be used as the first anti-counterfeiting mechanism of the present invention. Because the security pattern 11 can be printed in one time and combined with the established pattern on the surface of the external packing container 1, it can not only eliminate a label production procedure to simplify the processing procedure and to save labor and cost, but also do not affect the sense of beauty of the overall appearance of the external packing container 1 and achieve implementation of energy saving carbon reduction and environmental protection.

In the present preferred embodiment, the image capturing device 21 (digital camera, video camera) of the identification system 2 is equipped with a filter 211 that mates the specific spectral band of the tangible fluorescent ink. The filter 211 is adapted for filtering a specific spectral band (such as visible light in the range of 400˜700 nm). When a user uses the image capturing device 21 with the filter 211 to shoot the security pattern 11, it simply captures the pattern image of the spectral band (such as visible light in the range of 550±20 nm) and shape, and the light of other spectral bands will be removed. After capturing the pattern image, the processor 22 (computer or notebook computer) runs the follow-up pattern image recognition and verification procedure.

The processor 22 is electrically connected to the image capturing device 21 through a transmission cable or connection unit, having built therein a software program 221 and a database 222. Thus, the processor 22 can load in the pattern image being transmitted by the image capturing device 21. Thereafter, the software program 221 identifies the spectral band and shape within the image color block of the pattern image of the security pattern 11. In case of a counterfeit security pattern using a fluorescent ink of a different spectral band, the pattern image captured by the image capturing device 21 will show broken lines or incomplete shape. The software program 221 matches the spectral band of the pattern image with the preset tangible fluorescent ink data in the database 222 first, and then matches the shape of the pattern image with the preset tangible fluorescent ink data in the database 222 when the spectral band matched, achieving a second anti-counterfeit mechanism.

As described above, when the processor 22 uses the software program 221 to identify the spectral band and shape within the image color block of the pattern image of the security pattern, the software program 221 matches the spectral band and shape of the pattern image with the preset tangible fluorescent ink data in the database 222 for similar percentage comparison, and the matching is proved acceptable only when similar percentage reaches at least 98%. This procedure provides a third anti-counterfeit mechanism. After the processor 22 identified the spectral band and shape within the image color block of the pattern image of the security pattern to be in conformity with the storage data, the authenticity of the security pattern 11 is successfully recognized, and thus the user can clearly identify the internal goods in the external packing container 1 is genuine. The multiple anti-counterfeit mechanisms of the specific color, spectrum and shape of the security pattern 11 cannot be easily counterfeited, improving product safety and reducing the risk of being forged.

What the invention claimed is:

1. A pattern and spectrum security one-time printing of packaging verification method for verifying the authenticity of an external packing container of a commodity, said external packing container being printed with a security pattern on the surface thereof using a specific spectrum of tangible fluorescent ink, the pattern and spectrum security one-time printing of packaging verification method comprising the steps of:
(a) the user visually checking the location of said security pattern by visualizing said tangible fluorescent ink on the surface of said external packing container;
(b) the user using an image capturing device of said identification system to shoot said security pattern through a filter of said image capturing device so as to capture the pattern image of said tangible fluorescent ink of said security pattern; and
(c) enabling a processor of said identification system to load in the captured pattern image being transmitted by said image capturing device, and then enabling a software program in said processor of said identification system to match the spectral band and shape of said captured pattern image with storage data in said database so as to verify the authenticity of said security pattern.

2. The pattern and spectrum security one-time printing of packaging verification method as claimed in claim 1, wherein said specific spectrum of tangible fluorescent ink on said external packing container is in the range of 550±20 nm of visible light.

3. The pattern and spectrum security one-time printing of packaging verification method as claimed in claim 1, wherein said security pattern of said external packing container is directly printed on the surface of said external packing container in one time and incorporated into a predetermined pattern.

4. The pattern and spectrum security one-time printing of packaging verification method as claimed in claim 1, wherein said security pattern has a geometric shape of intersections of color and lines.

5. The pattern and spectrum security one-time printing of packaging verification method as claimed in claim 1, wherein said filter of said image capturing device is adapted for filtering the light of said security pattern in a specific spectral band, enabling said image capturing device to capture a pattern image of a specific color, spectrum and shape, and the specific spectral band being filtered by said filter is in the range of 400˜700 nm of visible light.

6. The pattern and spectrum security one-time printing of packaging verification method as claimed in claim 1, wherein said processor of said identification system has built therein a software program and a database for identifying the spectral band and shape within the image color block of the pattern image being transmitted by said image capturing device the, and the built-in software program of said processor is used to match the spectral band of said pattern image with the preset tangible fluorescent ink data in said database first and then to match the shape of said pattern image with the preset tangible fluorescent ink data in said database so as to successfully verify the authenticity of said security pattern.
